(19) United States
(12) Patent Application Publication
(10) Pub. No.: US 2003/0131918 A1
(43) Pub. Date: Jul. 17, 2003

(54) Multi-chamber safety tire

(76) Inventor: K. Kenneth Eng, Oak Brook, IL (US)

Correspondence Address: K. Kenneth Eng, MD, MPH, MBA, 1608 Midwest Club Parkway, Oak Brook, IL, 60523, US

(21) Appl. No.: 10/042,974

(22) Filed: Jan. 11, 2002

(51) Int. Cl. B60C 5/22

(52) U.S. Cl. 152/340.1; 152/339.1

(57) ABSTRACT

A new tire design superseding current conventional single-chamber tire design is delineated. This new invention incorporates the use of multiple independent chambers arranged side-by-side to improve vehicular safety and functionality. This design is an improvement over prior art utilizing concentric dual chambers by maintaining tire height in the event of a single chamber puncture. During such blow outs, steering and ride would be unimpeded, allowing driver to complete travel and replace damaged tire at a more convenient time. Much time will be saved in not requiring driver to either change the punctured tire immediately or to call and wait for road service assistance. This feature is especially important in military, police, or commercial applications where uninterrupted and unaffected travel is crucial to ensuring occupant safety, achieving mission objectives, or meeting delivery or travel deadlines.

### BACKGROUND

1. Field of Invention

This invention relates to safety tire design, with multiple chambers, uniquely arranged side-to-side, providing enhanced safety and utility.

2. Description of Prior Art

Current conventional tires are of single chamber in design. Efforts have been made to improve the safety and function of tires by the use of a dual-chamber design. The latest was issued to Blair as U.S. Pat. No. 5,538,061. This was preceded by Lambe, U.S. Pat. No. 4,293,017. Both patents, as well as others referenced by these two patents, utilized a concentric arrangement of chambers. Our unique design, in contradistinction, places two or more chambers side-to-side, and offer greater safety and utility.

### OBJECTS AND ADVANTAGES

Just as dual hull ships provide continued ship operation in the event of a breach of the exterior hull, the multi-chamber tire will allow continued unimpeded automobile function in the event of a tire puncture. The previously referenced dual-chamber designs with concentric chambers were improvements over the single chamber design. In the event of a tire puncture, the blow-out would be most likely limited to the outer chamber. With the inner chamber still intact, the vehicle may still be capable of continued function. However, once the outer chamber is breached, the tire height will decrease to the height of the inner chamber. Although this allows for continued function, the unequal tire height will cause the vehicle to be more unstable and more difficult to handle, requiring a reduction in vehicular speed in order to avoid an accident from lost of control.

In contrast, our side-to-side multi-chamber design provides greater safety and functionality. In the event one chamber is punctured, our side-to-side chamber arrangement will allow for maintenance of vertical height of the tire, and hence, steering and ride quality would be unaffected. With the concentric design, in comparison, if one chamber is punctured, the vertical height of the tire will be deformed to the height of the inner chamber. With one tire lower than the other three tires, steering and smoothness of the ride will be compromised, especially at high speeds, increasing the risk of lost of control of the vehicle, resulting in possibly a dangerous accident.

In the event of a single tire puncture, our design will allow the driver to continue his journey unimpeded, and to replace the damaged tire later at his convenience and probably at a lower cost. Much time will be saved in not requiring driver to either change the punctured tire immediately or to call and wait for road service assistance. This is especially important in military, police, or commercial applications where uninterrupted travel is crucial to ensuring occupant safety, achieving mission objectives, or meeting delivery or travel deadlines.

### DRAWING FIGURES

FIG. 1A shows a cross section of a two-chamber tire.

FIG. 1B shows an external side view of a two-chamber tire.

FIGS. 1A & 1B demonstrate that the chambers are arranged side-by-side, each independently inflated and separate from the other chamber. Although the internal design is radically different from conventional single-chamber tires, the external appearance would be indistinguishable, except for the presence of an additional valve stem. Drawings would be similar for designs with three or more chambers, as demonstrated in FIGS. 2A and 2B.

FIG. 2A shows a cross section of a three-chamber tire.

FIG. 2B shows an external side view of a three-chamber tire.

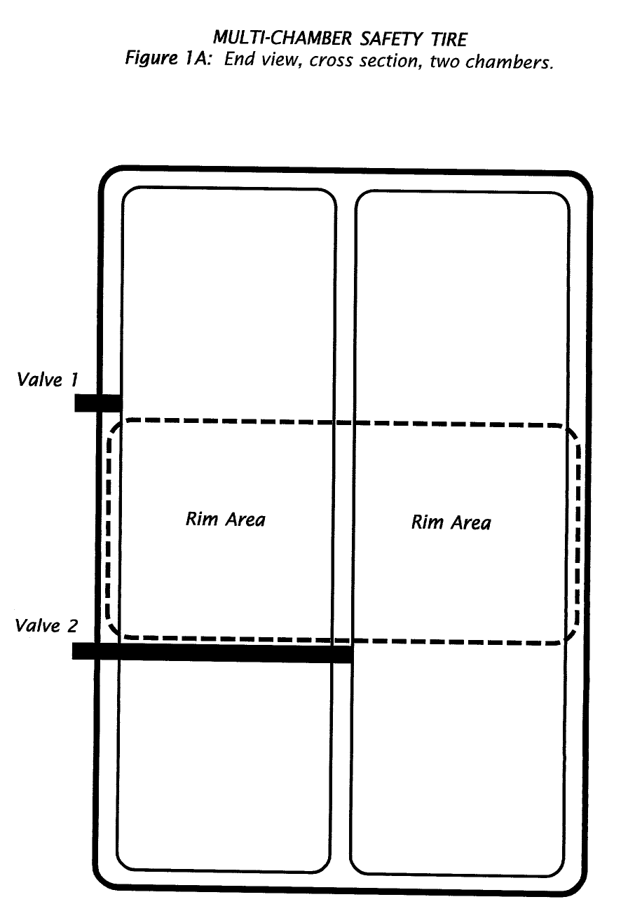

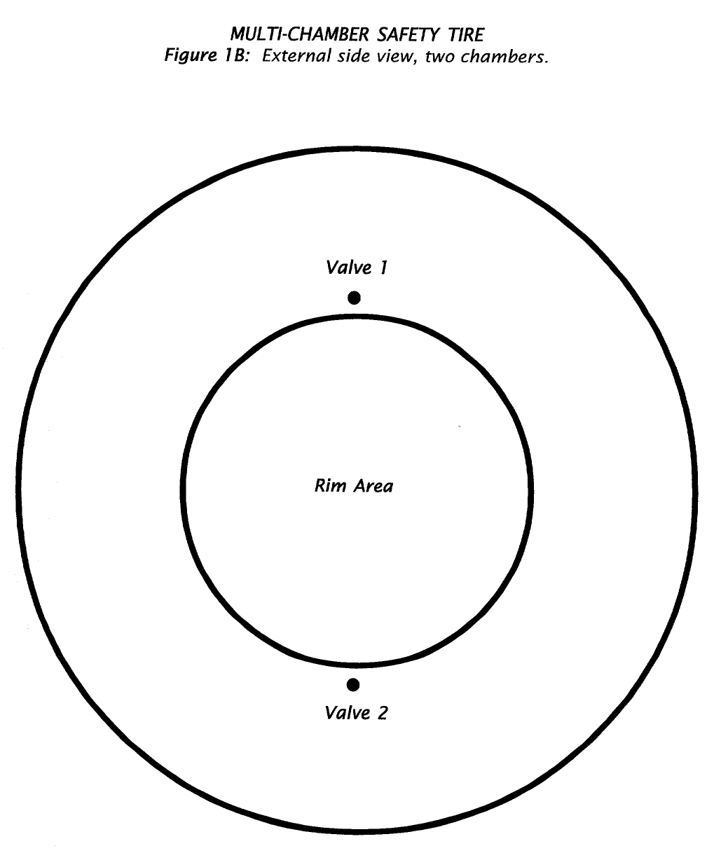

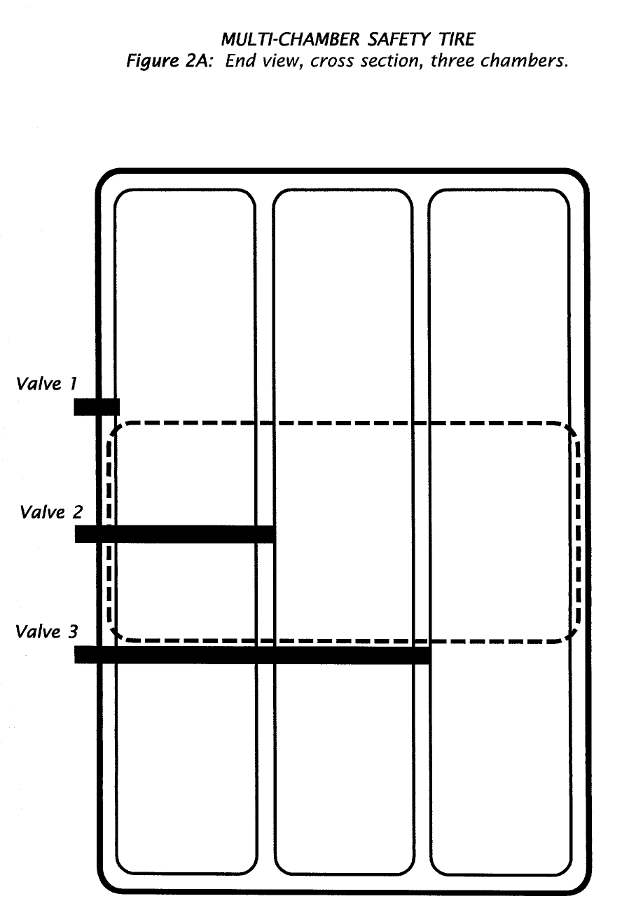

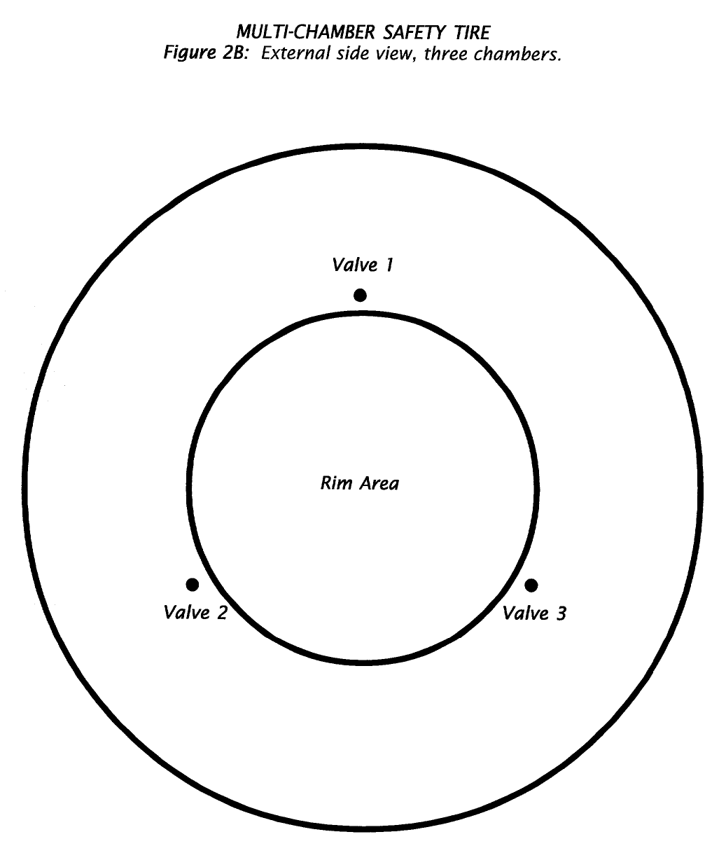

### SUMMARY, RAMIFICATIONS, AND SCOPE

Our multi-chamber tire design, with side-to-side placement of chambers, provides enhanced safety and utility compared with conventional tires. The design is also superior to prior art such and Blair's and Lambe's, which consist of a dual-chamber design, but concentrically placed. Our side-to-side multi-chamber design allows unimpeded function in the event of a single chamber puncture whereas the dual-chamber, concentric designs do not.

This unimpeded function will allow for significant time saving in not requiring the driver to stop and change the damaged tire or to wait for road side service. This is especially critical in military, police, or commercial applications where uninterrupted and unaffected travel is crucial to occupant safety, accomplishing mission objectives, or meeting delivery or travel deadlines.

I claim:

1. A means of improving tire safety and function by incorporating into the design independent multiple chambers arranged side-by-side.
